(19) United States
(12) Patent Application Publication
(10) Pub. No.: US 2011/0216432 A1
(43) Pub. Date: Sep. 8, 2011

(54) MAGNETIC HEAD COMPRISING TWO MAGNETIC FIELD SENSING PART

(75) Inventor: Takumi YANAGISAWA, Tokyo (JP)

(73) Assignee: TDK Corporation, Tokyo (JP)

(21) Appl. No.: 12/718,482

(22) Filed: Mar. 5, 2010

(51) Int. Cl. G11B 20/10; G11B 5/33; G11B 21/16

(52) U.S. Cl. 360/39; 360/315; 360/246.2; G9B/20.009; G9B/5.104; G9B/21.023

(57) ABSTRACT

A reading element of a magnetic head has a first magnetoresistive effect part (first MR part) and a second magnetoresistive effect part (second MR part), an electrical resistance of the first MR part changing according to an external magnetic field applied to a first magnetic field sense area, an electrical resistance of the second MR part changing according to an external magnetic field applied to a second magnetic field sense area. A width of the second magnetic field sense area in a track width direction of the recording medium is larger than a width of the first magnetic field sense area in the track width direction, and a phase of change in the electrical resistance of the second MR part with respect to the external magnetic field substantially reverses to or substantially the same as a phase in the electrical resistance of the first MR part. The magnetic head produces an output signal that comprises a sum or difference of a first sense signal and a second sense signal, the first sense signal being based on the change of the electrical resistance of the first MR part, the second sense signal being normalized to a predetermined amount and being based on the change of the electrical resistance of the second MR part, and determines the magnetic information written on the recording medium from the output signal.

### TECHNICAL FIELD

The present invention relates to a magnetic head, and further relates to a magnetic head having at least two magnetic field sensing (detection) parts.

### BACKGROUND

In association with high recording density on a hard disk drive (HDD), a magnetic head with high sensitivity and high output is in demand. One example of a magnetic head that satisfies this demand is a magnetic head using a magnetoresistive effect (MR) film whose electrical resistance changes according to an external magnetic field (see Japanese Laid-Open Publication No. H02-257412).

A magnetic head of a spin valve type has been invented as a magnetic head using such an MR film. In the spin valve head, as a reading element, a pair of ferromagnetic layers is disposed through a nonmagnetic intermediate layer. An antiferromagnetic layer is disposed in a contacting manner to one of the ferromagnetic layers. Due to an exchange-coupling between the one of the ferromagnetic layers and the antiferromagnetic layer, a magnetization direction of the one of the ferromagnetic layers is fixed in one direction. A magnetization direction of the other of the ferromagnetic layers freely rotates according to the external magnetic field. As described above, the ferromagnetic layer whose magnetization direction freely rotates according to the external magnetic field is also referred as a free layer. According to a change in a relative angle formed by the magnetization directions of the two ferromagnetic layers, an electrical resistance value of the spin valve head changes. Based on the change in the electrical resistance value, the external magnetic field, i.e. a magnetic field from a recording medium, can be detected. As a result, the magnetic head can determine magnetic information written on the recording medium.

Currently, a track pitch of the HDD has become narrower, and it is desired to further narrow a width of the reading element of the magnetic head in a track width direction. However, the reading element senses the external magnetic field of an area that is wider (broader) than an actual width of the reading element. In other words, magnetization of the free layer changes due to the external magnetic field of the area that is wider than the width of the track width direction of the free layer. Therefore, it has become difficult to provide a magnetic head that is compatible with the recording medium having a narrow track pitch only by narrowing the width of the reading element. There is also a manufacturing limitation for narrowing the width in the track width direction of the reading element.

Accordingly, instead of narrowing the width in the track width direction of the reading element, it is desired to develop a magnetic head that is compatible with the recording medium having a narrow track pitch.

### SUMMARY

An object of the present invention is to provide a magnetic head that is compatible with a recording medium having a narrow track pitch.

The magnetic head according to one embodiment of the present invention has a reading element that reads magnetic information written on the recording medium. The reading element has a first magnetoresistive effect part (first MR part) and a second magnetoresistive effect part (second MR part), an electrical resistance of the first MR part changing according to an external magnetic field applied to a first magnetic field sense area, an electrical resistance of the second MR part changing according to an external magnetic field applied to a second magnetic field sense area. A width of the second magnetic field sense area in a track width direction of the recording medium is larger than a width of the first magnetic field sense area in the track width direction. A phase of change in the electrical resistance of the second MR part with respect to the external magnetic field substantially reverses to a phase in the electrical resistance of the first MR part. The magnetic head produces an output signal that comprises a sum of a first sense signal and a second sense signal, the first sense signal being based on the change of the electrical resistance of the first MR part, the second sense signal being normalized to a predetermined amount and being based on the change of the electrical resistance of the second MR part, and determines the magnetic information written on the recording medium from the output signal.

The magnetic head according to the other embodiment of the present invention has a reading element that reads magnetic information written on the recording medium. The reading element has a first magnetoresistive effect part (first MR part) and a second magnetoresistive effect part (second MR part), an electrical resistance of the first MR part changing according to an external magnetic field applied to a first magnetic field sense area, an electrical resistance of the second MR part changing according to an external magnetic field applied to a second magnetic field sense area. A width of the second magnetic field sense area in a track width direction of the recording medium is larger than a width of the first magnetic field sense area in the track width direction. A phase of change in the electrical resistance of the second MR part with respect to the external magnetic field is substantially the same as a phase in the electrical resistance of the first MR part. The magnetic head produces an output signal that comprises a difference between a first sense signal and a second sense signal, the first sense signal being based on the change of the electrical resistance of the first MR part, the second sense signal being normalized to a predetermined amount and being based on the change of the electrical resistance of the second MR part, and determines the magnetic information written on the recording medium from the output signal.

In the magnetic head configured as described, a peak of the second sense signal obtained from the wide second MR part is broader than a peak of the first sense signal obtained from the first MR part. Accordingly, a width of the peak of the final output signal obtained from the first sense signal and the second sense signal, specifically a width of a skirt (skirt part) of the peak, becomes small. This means that an area where the magnetic head senses the magnetic field becomes small. Therefore, the magnetic head of the present invention can read the magnetic information of the recording medium having the narrow track pitch with higher accuracy.

The above-mentioned object, as well as other objects, characteristics, and advantages of the present invention will be described below with reference to attached drawings illustrating an embodiment(s) of the present invention.

### BRIEF DESCRIPTION OF THE DRAWINGS

FIG. 1 is a schematic cross sectional view of a magnetic head of a first embodiment of the present invention.

FIG. 2 is a schematic plan view of a reading element of the magnetic head of the first embodiment as seen from an air bearing surface (ABS).

FIG. 3 is a graph illustrating changes in electrical resistance of first and second MR parts corresponding to an external magnetic field.

FIG. 4 is a graph schematically illustrating sense signals S1 and S2 from the MR parts, and a final output signal S.

FIG. 5 is a graph illustrating a result of a simulated waveform of the output signal S produced based on the sense signals S1 and S2.

FIG. 6 is a graph illustrating an enlarged area E in the graph shown in FIG. 5.

FIG. 7 is a graph illustrating a relation between an output ratio between the first sense signal from the first MR part and the second sense signal from the second MR part, and a half width of an output peak of the output signal S.

FIG. 8 is a graph illustrating a ratio between a width of a skirt of a peak of the output signal and the half width of the output signal.

FIG. 9 is a schematic plan view of a reading element of a magnetic head of a second embodiment as seen from an ABS.

FIG. 10 is a schematic plan view of a reading element of a magnetic head of a third embodiment as seen from an ABS.

FIG. 11 is a graph illustrating changes in electrical resistance of the first and second MR parts according to the external magnetic fields of the magnetic head illustrated in FIG. 10.

FIG. 12 is a graph illustrating a result of a simulated waveform of an output signal S produced based on the sense signals S1 and S2.

FIG. 13 is a plan view of a wafer with respect to the manufacture of a thin film magnetic head of the present invention.

FIG. 14 is a perspective view of a slider of the present invention.

FIG. 15 is a perspective view of a head arm assembly including a head gimbal assembly in which the slider of the present invention is incorporated.

FIG. 16 is a side view of the head arm assembly in which the slider of the present invention is incorporated.

FIG. 17 is a plan view of a hard disk device in which the slider of the present invention is incorporated.

FIG. 18 is a schematic view illustrating operations where a head stack assembly of the hard disk device moves.

FIG. 19 is a schematic plan view of the magnetic head as seen from the ABS.

### DETAILED DESCRIPTION OF THE INVENTION

Hereafter, a thin film magnetic head of one embodiment of the present invention will be explained with reference to the drawings.

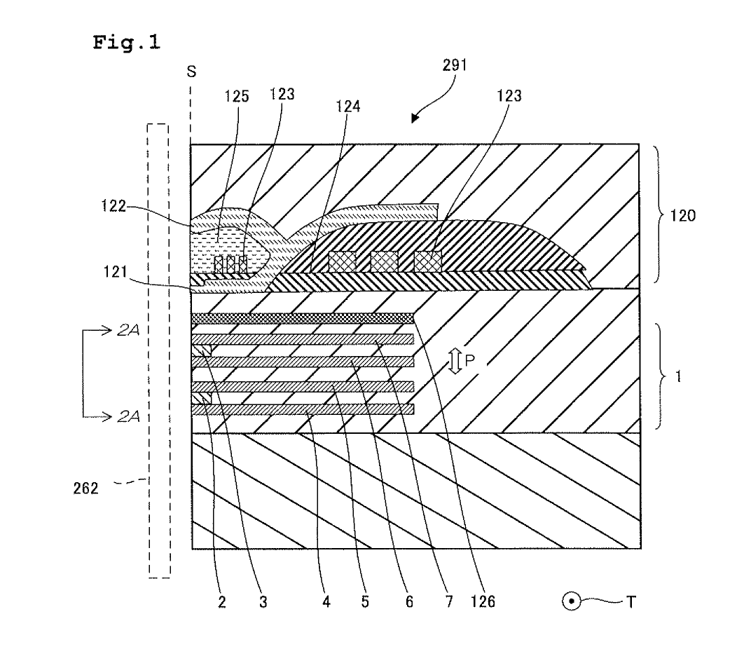

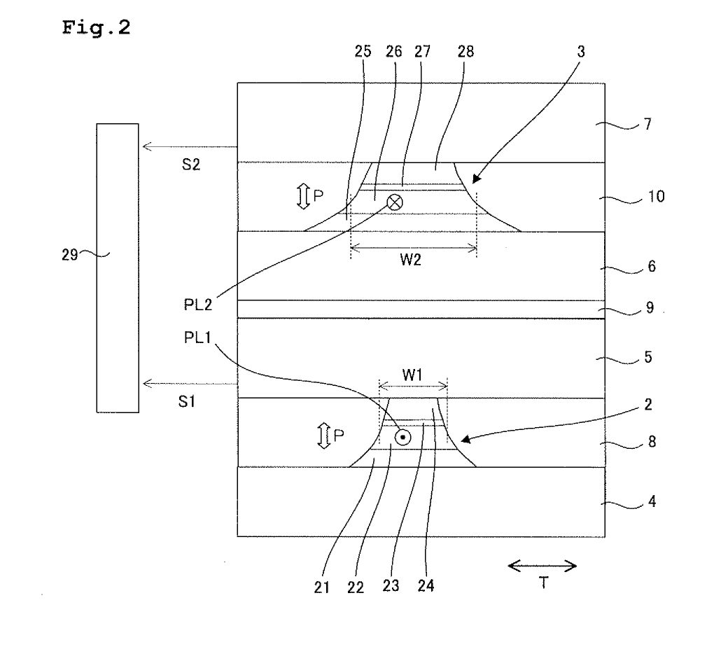

FIG. 1 is a side cross sectional view of a magnetic head of a first embodiment. FIG. 2 is a plan view of a reading element of the magnetic head as seen from a 2A-2A direction of FIG. 1, i.e., an air bearing surface (ABS) S opposite to a recording medium.

The magnetic head 291 has a reading element 1 for detecting (reading) magnetic information written on a recording medium 262, and a writing element 120 for writing magnetic information on the recording medium 262. In the present embodiment, the magnetic head 291 having the reading element 1 and the writing element 120 will be explained. However, the magnetic head having only the reading element 1 also can be used as the magnetic head of the present invention.

FIG. 2 is a schematic plan view of the reading element 1 of the magnetic head 291 of the first embodiment as seen from the ABS S. The reading element 1 has a first MR part 2 and a second MR part 3 that are exposed to the ABS S. The MR parts 2 and 3 can be configured in any configuration as long as the electrical resistance value under such a configuration changes according to the external magnetic field. Specifically, the MR parts 2 and 3 are each configured as a stack (hereafter, sometimes referred to as an MR stack) exhibiting a magnetoresistive effect.

In the present embodiment, as a preferable example, a so-called spin-valve type MR element (a spin-valve element) is used for the MR parts 2 and 3. The first MR part 2 is sandwiched between a pair of shield layers 4 and 5 in a film surface orthogonal direction P of the MR stack. Similarly, the second MR part 3 is sandwiched between a pair of shield layers 6 and 7 in the film surface orthogonal direction P of the MR stack. These shield layers 4, 5, 6 and 7 function to prevent an external magnetic field generated by an adjacent bit arranged on the same track of the recording medium 262 from being applied to a free layer, and function as electrodes that enable a sense current to flow through the MR stack.

In the present embodiment, the shield layer 5 and the shield layer 6 are insulated by an insulating layer 9. Alternatively, both shield layers 5 and 6 can be formed in an integrated manner without arranging the insulating layer 9 between the shield layer 5 and the shield layer 6.

The two MR stacks configuring the first MR part 2 and the second MR part 3 are configured in the same manner. Each of the MR stacks is formed such that antiferromagnetic layers (pinning layers) 21 and 25, first ferromagnetic layers (pinned layers) 22 and 26, nonmagnetic intermediate layers (spacer layers) 23 and 27, and second ferromagnetic layers (free layers) 24 and 28 are respectively laminated in this order. These layers may also be laminated in a reverse order.

The nonmagnetic intermediate layers 23 and 27 can be made of for example, a nonmagnetic conductor such as copper (Cu), or a nonmagnetic insulator such as, for example aluminum oxide (AlOx) or magnesium oxide (MgO). The antiferromagnetic layers 21 and 25 are preferably made of a platinum-manganese alloy (PtMn) or an iridium-manganese alloy (IrMn).

Materials and a thickness of each layer configuring the first MR part 2 may be either the same as or different from materials and a thickness of each layer configuring the second MR part 3. Moreover, a lamination configuration of the first MR part 2 may be different from a lamination configuration of the second MR part 3.

Magnetizations of the second ferromagnetic layers (free layers) 24 and 28 change according to the external field. The second ferromagnetic layers 24 and 28 are made of for example, CoFe/NiFe or the like. The first ferromagnetic layers (pinned layers) 22 and 26 are exchange-coupled with the antiferromagnetic layers 21 and 25. This causes magnetization directions PL1 and PL2 of the first ferromagnetic layers 22 and 26 to be fixed.

A relative angle between the magnetization direction of the first ferromagnetic layer 22 and a magnetization direction of the second ferromagnetic layer 24 changes according to the direction of the external magnetic field. The electrical resistance value of the first MR part 2 changes according to the change of the relative angle. Similarly, a relative angle between the magnetization direction of the first ferromagnetic layer 26 and a magnetization direction of the second ferromagnetic layer 28 changes according to the direction of the external magnetic field. The electrical resistance value of the second MR part 3 changes according to the change of this relative angle. As described above, each of the MR parts 2 and 3 essentially includes a pair of the ferromagnetic layers where the relative angle of the magnetizations changes according to the external magnetic field, and the free layers 24 and 28 whose magnetization directions change according to the external magnetic field configure magnetic field sense areas where a change in the external magnetic field is sensed.

In the present embodiment, the magnetization direction PL1 of the first ferromagnetic layer 22 of the first MR part 2 is substantially in an opposite direction to the magnetization direction PL2 of the second ferromagnetic layer 26 of the second MR part 3. Magnetizations of the pinned layers 22 and 26 can be directed in a desired direction by an annealing treatment in a predetermined magnetic field.

A width W2 of the second ferromagnetic layer 28 of the second MR part 3, i.e. the magnetic field sense area, in a track width direction T is wider than a width W1 of the ferromagnetic layer 24 of the first MR part 2, i.e. the magnetic field sense area, in the track width direction T.

A signal processing device 29 is included in the magnetic head 291 or a separate device such as, for example, a hard disk device. The signal processing device 29 produces a final output signal S by processing the first sense signal S1 from the first MR part 2 and the second sense signal S2 from the second MR part 3. The signal processing device 29 produces a sum of the first sense signal S1 and the second sense signal S2 as the output signal S. Herein, the second sense signal is normalized to a predetermined amount. Herein, the second sense signal S2 is normalized such that an absolute value of a peak value of the second sense signal S2 is smaller than an absolute value of a peak value of the first sense signal S1, and more preferably less than the half of the absolute value of the first sense signal S1.

The sense signals S1 and S2 obtained from the MR parts 2 and 3 do not have to be the electrical resistance value itself, and may be signals that are obtained by using voltage changes or current changes according to the change in the electrical resistance value. For example, under a condition where a constant voltage is applied to the MR parts 2 and 3, an amount of the sense current flowing in the MR parts 2 and 3 may be detected as the sense signal. Instead of such a method, under a condition where the constant sense current flows in the MR parts 2 and 3, a potential difference between both of sides in the lamination direction of the MR stack that configures the MR parts 2 and 3 may be detected as the sense signal.

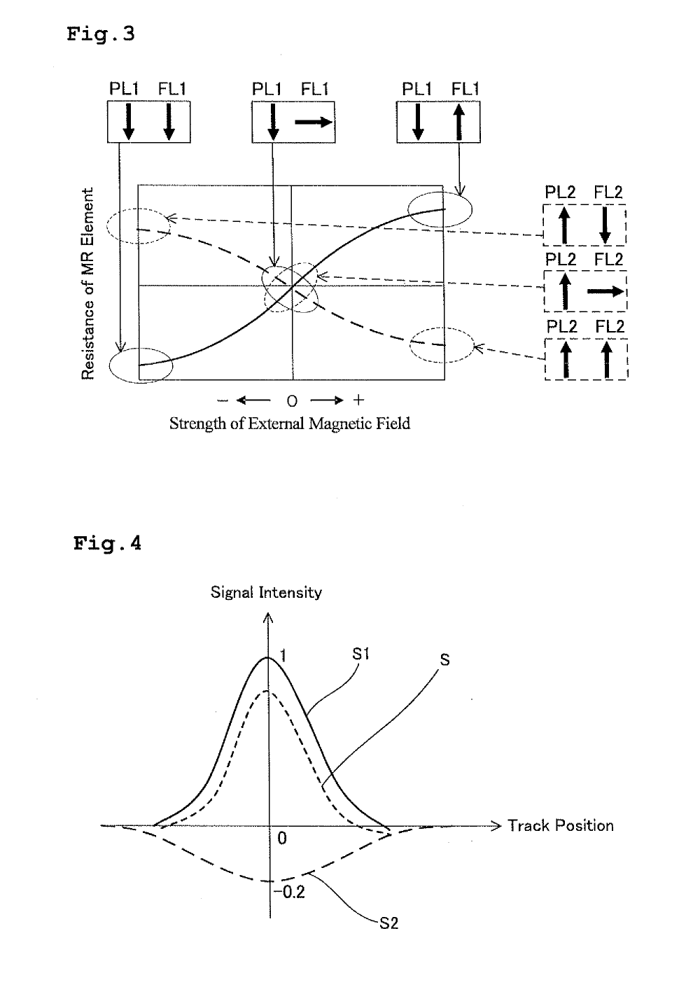

An operating principle will be explained for detecting the external magnetic field, i.e., reading the magnetic information of the recording medium by the above-described magnetic head 291. FIG. 3 illustrates a relationship between the resistances of the first MR part 2 and the second MR part 3, and a strength of the external magnetic field. A solid line illustrates the resistance of the first MR part 2, and a dotted line illustrates the resistance of the second MR part 3. Additionally, in FIG. 3, a sign FL1 illustrates a magnetization direction of the free layer 24 of the first MR part 2, and a sign FL2 illustrates a magnetization direction of the free layer 28 of the second MR part 3.

In the present embodiment, a magnetization direction PL1 of the first ferromagnetic layer 22 of the first MR part 2 is in a substantially opposite direction to a magnetization direction PL2 of the second ferromagnetic layer 26 of the second MR part 3. Therefore, when a relative angle between the magnetization direction of the first ferromagnetic layer 22 and the magnetization direction of the second ferromagnetic layer 24 is small in the first MR part 2, a relative angle between the magnetization direction of the first ferromagnetic layer 26 and the magnetization direction of the second ferromagnetic layer 28 becomes large in the second MR part 3. Additionally, when a relative angle between the magnetization direction of the first ferromagnetic layer 22 and the magnetization direction of the second ferromagnetic layer 24 is large in the first MR part 2, a relative angle between the magnetization direction of the first ferromagnetic layer 26 and the magnetization direction of the second ferromagnetic layer 28 becomes small in the second MR part 3. As described above, a phase of the resistance value with respect to the external magnetic field of the first MR part 2 is substantially shifted by 180° from the resistance value with respect to the external magnetic field of the second MR part 3. Therefore, when a sense signal, where the strength of the external magnetic field is zero, is set as zero, a sense signal S1 from the first MR part 2 has a value that is the inverse of a sense signal S2 from the second MR part 3.

FIG. 4 illustrates the sense signals S1 and S2 where the magnetic information written only on one track of the recording medium is read by the above-described magnetic head 291, and the final output signal S. Herein, a horizontal axis of the graph illustrates a position (a track position) of a track width direction T of the magnetic head 291. Additionally, a point, which a center of a magnetic field sense area of each of the MR parts 2 and 3 is located at a center of a track of the recording medium, is normalized (defined) as an origin of the horizontal axis.

As illustrated in FIG. 4, the sense signals S1 and S2 from each of the MR parts 2 and 3 show peaks (maximum and minimum values) when the magnetic head is positioned directly above the track. When an identical magnetic field is applied to the first MR part 2 and the second MR part 3, signs of the sense signals S1 and S2 obtained from each of the MR parts are inverted relative to one another. Also, the peak of the sense signal S2 is broader than the peak of the sense signal S1. This is because the width W2 of the magnetic field sense area of the second MR part 3 in the track width direction T is wider, and because a wider area of the external magnetic field can be sensed. In other words, even if the center of the magnetic field sense area is shifted from the center of one track of the recording medium, the vicinity of an edge part of the magnetic field sense area having the wider width is still affected by an effect of the magnetic field from the track.

The signal processing device 29 produces a sum of the first sense signal S1 and the second sense signal S2 that is normalized in the predetermined size as the output signal S. Since the second sense signal S2 has a reverse sign against the first sense signal S1, the output signal S generally has a waveform of which the magnitude (signal intensity) is suppressed relative to that of the first sense signal S1. Herein, since the peak of the second sense signal S2 is broader than the peak of the first sense signal S1, a ratio of the value at the skirt part of the peak of the second sense signal S2 with respect to the value at the skirt part of the first sense signal S1 is larger than a ratio of the maximum value of the second sense signal S2 with respect to the maximum value of the first sense signal S1. Therefore, compared with the first sense signal S1, the waveform of the output signal S produced by the signal processing device 29 exhibits a suppressed signal intensity at the skirt part of the peak, i.e., the peak width (especially a width at the skirt part of the peak) is decreased.

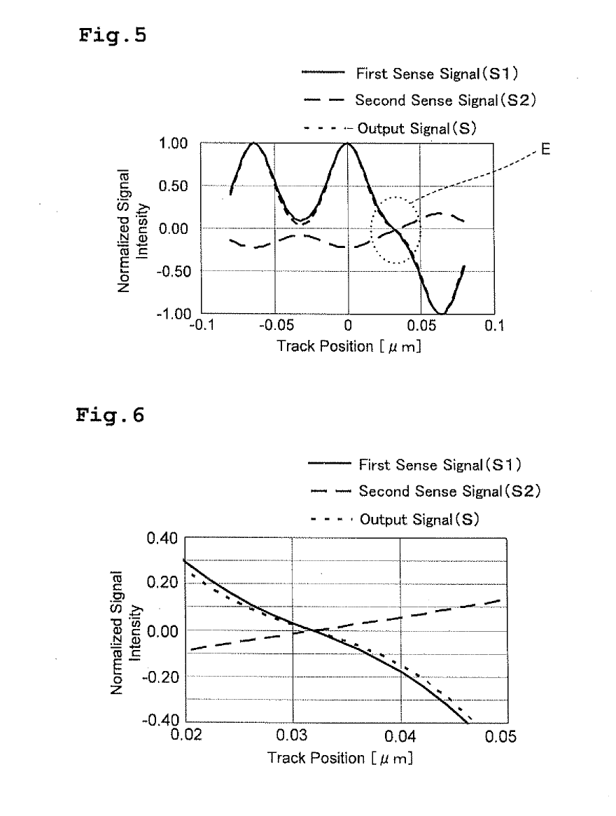

FIGS. 5 and 6 illustrate a result in which each peak of the sense signals S1 and S2 is approximated by the Gaussian function and the waveform of the output signal S is simulated. FIG. 6 illustrates a graph in which the vicinity of an area E of FIG. 5 is enlarged. A horizontal axis represents the track position of the magnetic head 291. Herein, a standard deviation of each peak of the first sense signal S1 is 0.016 μm, each peak being the Gaussian distribution type, and the standard deviation of each peak of the second sense signal S2 is 0.0128 μm, each peak being the Gaussian distribution type. The first sense signal S1 and the output signal S are normalized such that these absolute values are 1. Also, the second sense signal S2 is normalized such that the absolute value of the peak value is 0.2 times as large as the absolute value of the peak value of the first sense signal S1. Additionally, in this simulation, the three peaks with respect to the magnetic fields from the adjacent three tracks are shown.

Referring to FIG. 5, the output signal S has the almost same waveform as the first sense signal S1. However, referring to FIG. 6, it can be understood that the absolute value of the signal intensity at the skirt part of the peak of the output signal S is smaller than the absolute value at the skirt part of the peak of the first sense signal S1. As described above, the width of the skirt part of the peak of the output signal S is smaller than the width of the skirt part of the peak of the first sense signal S1.

This means that the output signal S rapidly decreases as the magnetic head is shifted from the center of the track, and that the magnetic head 291 of the present embodiment can accurately read the magnetic information of the recording medium having the narrow track pitch.

The signal processing device 29 can be configured with an analog/digital (A/D) converter circuit for converting the first sense signal S1 to a first digital signal and transforming the second sense signal S2 to a second digital signal, and an operation part for conducting a calculation process of the first digital signal and the second digital signal. In this case, the signal processing device 29 is incorporated in a device that is separately arranged from the magnetic head 291, i.e., the hard disk device.

When the signal processing device 29 converts the sense signals S1 and S2 to the digital signals and proceeds, there is an advantage in which the first MR part 2 and the second MR part 3 do not have to simultaneously read the magnetic field from one bit of the recording medium. This is because, by storing the digital signal in a memory, positions of peak signals corresponding to the magnetic information from the same bit are synchronized, the calculation process of the first sense signal S1 and the second sense signal S2 is performed, and thereby the predetermined output signal S can be easily obtained. Therefore, the first MR part 2 and the second MR part 3 may be arranged at a certain interval such that they are positioned on different bits when the magnetic head 291 faces the recording medium 262.

The signal processing device 29 may be an analog circuit for producing the predetermined output signal S from the first sense signal S1 and the second sense signal S2. Such an analog circuit is configured with an amplifier circuit or a reduction circuit, and an analog adder circuit. The amplifier circuit amplifies the first sense signal S1 and/or the second sense signal S2 to a predetermined amount, and the reduction circuit reduces the first sense signal S1 and/or the second sense signal S2 to a predetermined amount. In this case, the signal processing device 29 can be incorporated in the magnetic head 291. Also in this case, the first MR part 2 and the second MR part 3 are preferably arranged close to one another so as to simultaneously sense the magnetic field from the one bit of the recording medium. This is because the calculation with respect to the first sense signal and the second sense signal can be performed by synchronizing the positions of the peak signals corresponding to the magnetic information from the same bit.

A width W1 of the second ferromagnetic layer 24 of the first MR part 2, i.e. a magnetic field sense area, in the track width direction is preferably as small as possible. This enables the MR part 2 to correspond to the recording medium having the narrower track pitch. On the other hand, the half width (full width at half maximum) of the peak of the sense signal S2 of the second MR part 3 is preferably equal to or less than the track width of the recording medium 262. This is because when the half width of the peak of the sense signal S2 is wider than the track width, the second MR part 3 is affected by the magnetic field from the adjacent track and it becomes difficult to accurately read the magnetic information. Since the half width of the peak of the sense signal S2 depends on the actual width W2 in the track width direction T of the second ferromagnetic layer 28 of the second MR part 3, i.e., the magnetic field sense area, the limitation with respect to the half width of the sense signal S2 indirectly normalizes the width W of the second ferromagnetic layer 28 of the second MR part 3.

Next, regarding the following three examples, a simulation result will be explained with respect to a relation between a size of the second sense signal S2 in relation to the first sense signal S1 and the produced output signal S when the signal processing device 29 produces the output signal S. As shown in Table 1, in the first through third examples, each half width of the peak of the second sense signal S2 from the second MR part 3 varied. This means that the width W2 of the second ferromagnetic layer 28 of the second MR part 3 varied.

TABLE 1

| | Half Width of Peak of | Half Width of Peak of | Ratio of |
|---|---|---|---|
| | First Sense Signal S1 | Second Sense Signal | Half Widths |
| | (HW1) [μm] | S2 (HW2) [μm] | (HW2/HW1) |
| First | 0.043 | 0.055 | 1.290 |
| Example | | | |
| Second | 0.043 | 0.069 | 1.620 |
| Example | | | |
| Third | 0.043 | 0.087 | 2.050 |
| Example | | | |

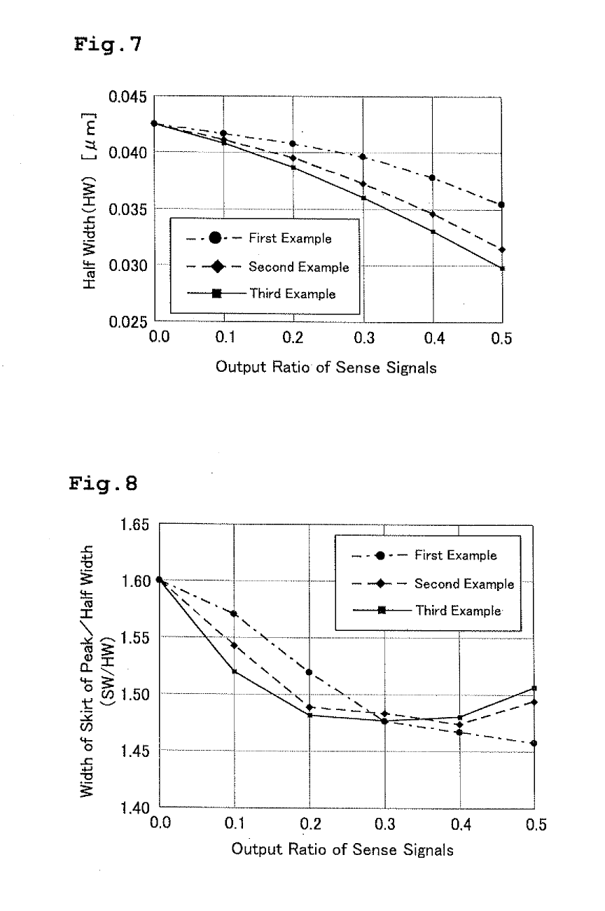

Regarding each of the examples, a value of a ratio (hereafter, referred to as an output ratio of the sense signal) of an absolute value of a peak value of the sense signal S2 with respect to an absolute value of a peak value of the sense signal S1 was changed, and the final output signal S was produced. FIG. 7 is a graph illustrating a relationship between the output ratio of the sense signal and the half width of the output peak of the output signal S. Herein, a state where the output ratio of the sense signal was zero means a state where the output signal S was the first sense signal S1, and it can be estimated as a conventional magnetic head having substantially a single MR part. When referring to FIG. 7, in the first through third examples, as the output ratio of the sense signal increased, the half width HW of the output signal S decreased.

FIG. 8 illustrates a ratio SW/HW (hereafter, simply referred to as a peak width ratio) between a width SW (hereafter referred as a width of skirt of peak) of the output signal S where the width is one-tenth of the absolute value of the peak value, and a half width HW of the output signal S. Since a state where the peak width ratio SW/HW is small describes a state where the breadth of the skirt of the peak of the output signal is small, the smaller the peak width ratio SW/HW is, the less the magnetic head is affected by the magnetic field from the adjacent track.

When referring to FIG. 8, in the first through third examples, as the output ratio of the sense signal increased, the value of the peak width ratio SW/HW generally decreased. At least when the output ratio of the sense signal was more than 0, and 0.5 or less, the value of the peak width ratio SW/HW was smaller than the value of the peak width ratio (1.60 in the example illustrated in FIG. 8) calculated only from the first sense signal S1. Accordingly, it is preferable that the signal processing device 29 produces a sum of the second sense signal S2 and the first sense signal S1 as the output signal S, where the second sense signal S2 is normalized to be more than 0% and 50% or less of the peak value of the first sense signal S1. Thereby, it becomes possible to read the magnetic information written on the recording medium having a narrower track width than the track width that is compatible with a single MR part.

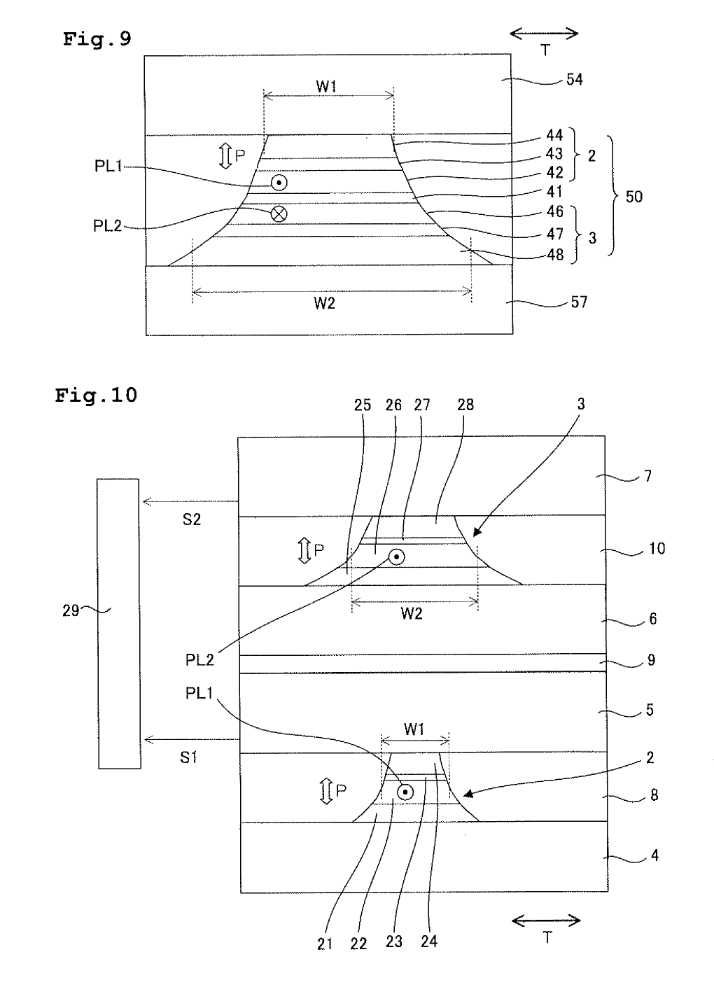

FIG. 9 is a schematic plan view of a reading element of a magnetic head of a second embodiment seen from an ABS S. In the second embodiment, a first MR part 2 and a second MR part 3 are arranged in a stack 50 in an integrated manner. Specifically, the stack 50 has the first MR part 2 having a first ferromagnetic layer (a pinned layer) 42, a nonmagnetic intermediate layer (a spacer layer) 43 and a second ferromagnetic layer (a free layer) 44, and the second MR part 3 has a first ferromagnetic layer (a pinned layer) 46, a nonmagnetic intermediate layer (a spacer layer) 47 and a second ferromagnetic layer (a free layer) 48. A single antiferromagnetic layer (a pinning layer) 41 is arranged between the pinned layer 42 of the first MR part 2 and the pinned layer 46 of the second MR part 3.

As described above, the antiferromagnetic layer 41 that is a single layer functions to fix a magnetization direction of the first ferromagnetic layer 42 of the first MR part 2, and also functions to fix a magnetization direction of the first ferromagnetic layer 46 of the second MR part 3. Thereby, even if there are two layers for the free layers 44 and 48 that sense an external magnetic field, a total thickness of the stack 50 can be reduced. Therefore, in order that the first MR part 2 and the second MR part 3 can simultaneously read magnetic information of a single bit, the first MR part 2 and the second MR part 3 can be arranged closely in a track direction of a recording medium (substantially the same direction as a film surface orthogonal direction P of the stack illustrated in FIG. 9).

In the second embodiment, a magnetization direction PL1 of the pinned layer 42 of the first MR part 2 and a magnetization direction PL2 of the pinned layer 46 of the second MR part 3 are in opposite directions. Also, the stack 50 including the first MR part 2 and the second MR part 3 has a trapezoidal shape whose width tapers in a direction from the lower layer to the upper layer. Thereby, a width W2 in the track width direction T of the second ferromagnetic layer (the free layer) 48 of the second MR part 3 is wider than a width W1 in a track width direction T of the second ferromagnetic layer (the free layer) 44 of the first MR part 2.

In addition, shield layers 54 and 57 are arranged at an upper layer side and a lower layer side, respectively of the stack 50 that is formed in an integrated manner. A sense current flows from the shield layers 54 and 57 through the stack 50 entirely that includes the first MR part 2 and the second MR part 3. In this case, a resistance value of the stack 50 is a sum of resistances values of the first MR part 2 and the second MR part 3 (and the pinning layer 41). Accordingly, an output signal from the stack 50 corresponds to the sum of a sense signal from the first MR part 2 and a sense signal from the second MR part 3. In other words, the integrated stack 50 itself functions as a device for producing a final output signal based on the sense signals from the two MR parts 2 and 3. Therefore, similar to the magnetic head of the first embodiment, the magnetic head of the second embodiment also can read the magnetic information of a recording medium having a narrow track width.

As described above, in the present specification, the sense signal means not only a signal that is directly measured but also a signal that is not directly measured (resistance value, voltage value, current value or the like).

According to the configuration of the second embodiment, as in the first embodiment, an analog circuit, etc. as the signal processing device 29 is not required so that the configuration of the magnetic head can be simplified.

Materials, thicknesses or the like of each film configuring the stack 50 may be selected in view of design purposes. A size of the resistance value (corresponding to a size of the sense signal) of each of the MR parts 2 and 3 depends on the materials and thicknesses. Accordingly, by properly choosing the materials, thicknesses or the like, the size of the resistance of the second MR part 3 in relation to the size of the resistance value of the first MR part 2 can be controlled.

FIG. 10 is a schematic plan view of a reading element of a magnetic head of a third embodiment seen from an ABS. The reading element has a first MR part 2 and a second MR part 3. Configurations of these MR parts 2 and 3 are the same as the configurations of the MR parts explained in the first embodiment. However, in the third embodiment, a magnetization direction PL1 of a pinned layer 22 configuring the first MR part 2 and a magnetization direction PL2 of a pinned layer 26 configuring the second MR part 3 are substantially in the same directions.

Similar to the first and second embodiments, a width W2 of a magnetic field sense area of the second MR part 3, i.e., of a free layer 28, is wider than a width W1 of a magnetic field sense area of the first MR part 2, i.e., of a free layer 24.

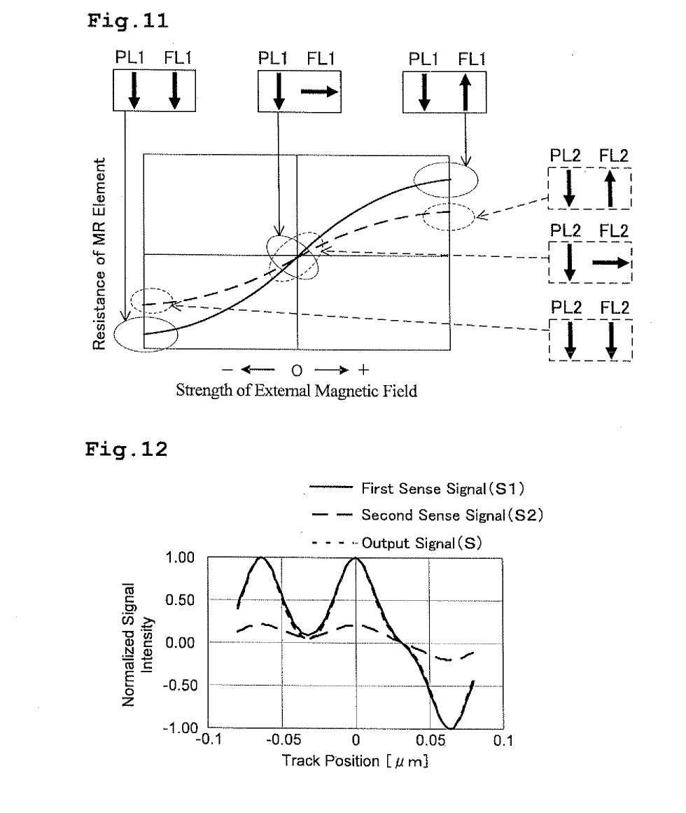

Using the magnetic head of the third embodiment, an operating principle will be explained with respect to reading magnetic information of a recording medium. FIG. 11 illustrates a relationship between resistances (resistance values) of the first MR part 2 and the second MR part 3, and strength of an external magnetic field. A solid line indicates the resistance value of the first MR part 2, and a dotted line indicates the resistance value of the second MR part 3. In addition, in FIG. 11, a sign FL1 indicates a magnetization direction of the free layer 24 of the first MR part 2, and a sign FL2 indicates a magnetization direction of the free layer 28 of the second MR part 3.

In the present embodiment, the magnetization direction PL1 of the first ferromagnetic layer 22 of the first MR part 2 is substantially in the same direction as the magnetization direction PL2 of a first ferromagnetic layer 26 of the second MR part 3. Therefore, being different from the first embodiment, a phase of the resistance with respect to the external magnetic field of the first MR part 2 is substantially the same as one of the resistance value with respect to the external magnetic field of the second MR part 3.

FIG. 12 illustrates sense signals S1 and S2 where magnetic information written on the recording medium is read by the magnetic head of the third embodiment and a final output signal S. Herein, a horizontal axis of the graph indicates a track position of the magnetic head 291. Additionally, a point, where a center of a magnetic field sense area of each of the MR parts 2 and 3 is positioned in a center of one track recording the magnetic information, is normalized as an origin of the track position.

As illustrated in FIG. 12, the sense signals S1 and S2 from each of the MR parts 2 and 3 show peaks (maximum and minimum values) when the magnetic head is positioned directly above the track. In the third embodiment, when the same magnetic field is applied to the first MR part 2 and the second MR part 3, signs of the sense signals S1 and S2 obtained from each of the parts are the same.

Also, the peak of the second sense signal S2 is broader than the peak of the first sense signal S1. This is because a width W2 of the magnetic field sense area of the second MR part 3 is wide and the second MR part 3 can sense the external magnetic field in a wider area.

The signal processing device 29 produces a difference between the first sense signal S1 and the second sense signal S2 that is normalized to a predetermined amount as the output signal S. Herein, since the second sense signal S2 has a value that is inverted compared to that of the first embodiment, the output signal S produced by the signal processing device 29 has the same waveform as that of the output signal S described in the first embodiment. Therefore, the magnetic head of the third embodiment also has the same advantage of the magnetic head as the first embodiment. Additionally, in FIG. 12, the output signal S is normalized such that the peak value is “1”.

Next, referring to FIG. 1, a configuration of the writing element 120 will be explained in detail. The writing element 120 is arranged on the reading element through an interelement shield layer 126 formed by a sputtering method, etc. The writing element 120 has a so-called vertical magnetic recording configuration. The magnetic pole layer for writing is formed with a main magnetic pole layer 121 and an auxiliary magnetic pole layer 122. The main magnetic pole layer 121 and the auxiliary magnetic pole layer 122 are formed by a frame plating method, etc. The main magnetic pole layer 121 is made of FeCo, and is exposed in the direction substantially perpendicular to a recording medium opposite surface S on the ABS S. A coil layer 123 extending over a gap layer 124 made of an insulating material is wound around the main magnetic pole layer 121, and magnetic flux is directed to the main magnetic pole layer 121 by the coil layer 123. The coil layer 123 is formed by a frame plating method, etc. The magnetic flux is directed to the inside of the main magnetic pole layer 121, and is extended to the recording medium 262 from the ABS S. The main magnetic pole layer 121 is tapered not only in the film surface orthogonal direction P but also in a track width direction T (sheet surface orthogonal direction in FIG. 1) in the vicinity of the ABS S, and a minute and strong writing magnetic field responding to high recording density is generated.

The auxiliary magnetic pole layer 122 is a magnetic layer that is magnetically coupled with the main magnetic pole layer 121. The auxiliary magnetic pole layer 122 is a magnetic pole layer formed with an alloy made of any two or three of Ni, Fe and Co or the like with approximately 0.01 μm to approximately 0.5 μm of film thickness. The auxiliary magnetic pole layer 122 is arranged in a manner of branching from the main magnetic pole layer 121, and faces the main magnetic pole layer 121 via the gap layer 124 and the coil insulating layer 125 at the ABS S. An edge part of the auxiliary magnetic pole layer 122 on the ABS side forms a trailing shield part of which the cross section is wider than any other part of the auxiliary magnetic pole layer 122. Establishment of such an auxiliary magnetic pole layer 122 causes a steeper magnetic field gradient between the auxiliary magnetic pole layer 122 and the main magnetic pole layer 121 in the vicinity of the ABS S. As a result, signal output jitter decreases and the error rate during a reading process is reduced.

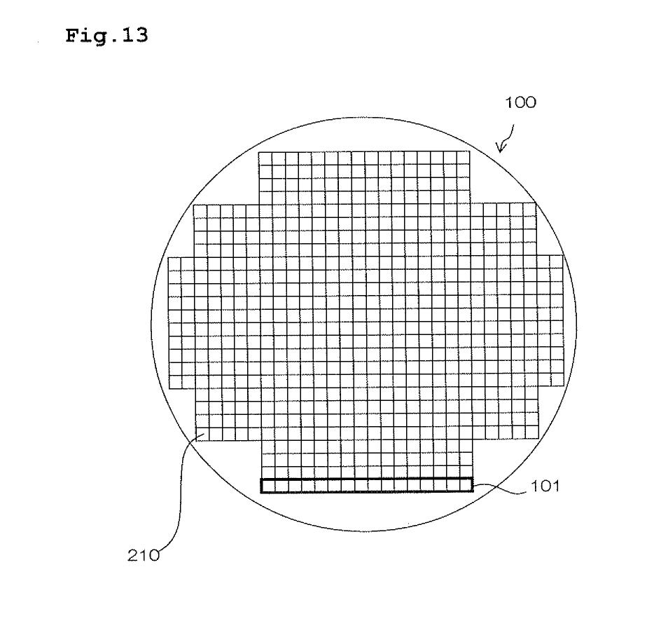

Next, a wafer used for manufacturing the above mentioned thin film magnetic head will be explained. Referring to FIG. 13, a stack configuring at least the above-described thin film magnetic head is formed on a wafer 100. The wafer 100 is divided into a plurality of bars 101, which are work units for polishing the ABS S. The bar 101 is further cut after being polished, and is divided into sliders 210 containing a thin film magnetic head. Cutting margins (not shown) are disposed in the wafer 101 for cutting the wafer 100 into the bars 101 and the bars 101 into the sliders 210.

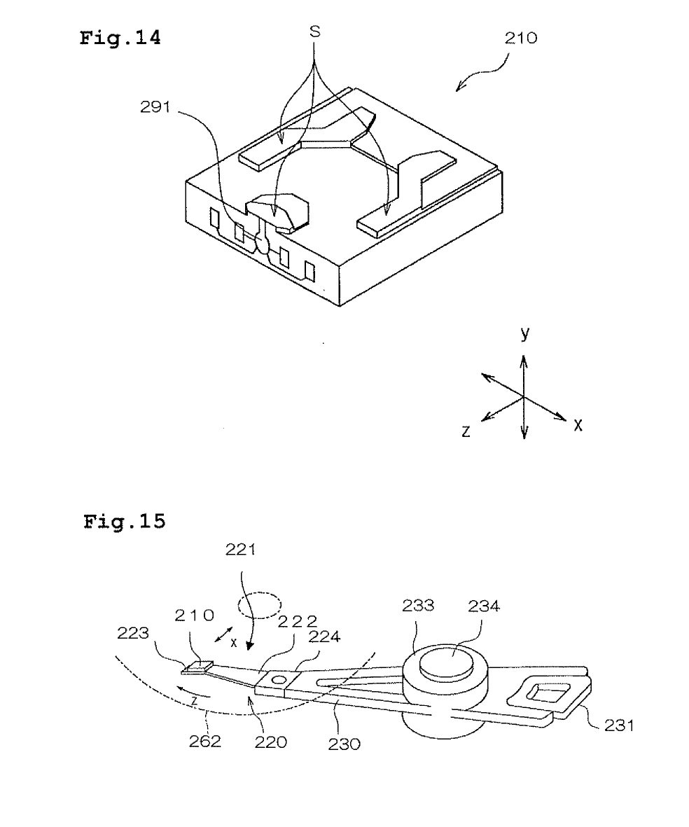

Referring to FIG. 14, the slider 210 has a substantially hexahedral shape, and one surface of the six surfaces is the ABS S facing the hard disk.

Referring to FIG. 15, a head gimbal assembly 220 has the slider 210 and a suspension 221 elastically supporting the slider 210. The suspension 221 has a load beam 222, a flexure 223, and a base plate 224. The load beam 222 is formed in a plate (leaf) spring shape and made of stainless steel. The flexure 223 is disposed in one edge part of the load beam 222. The base plate 224 is disposed in the other edge part of the load beam 222. The flexure 223 joins the slider 210 to give the slider 210 suitable flexibility. At the part of the flexure 223 to which the slider 210 is attached, a gimbal part is disposed to maintain the slider 1 in an appropriate position and orientation.

The slider 210 is disposed in the hard disk device such that the slider 210 is opposite to the recording medium. The recording medium is disk shaped and rotatably driven. When the hard disk rotates in the z-direction of FIG. 15, air flow passing between the hard disk and the slider 210 generates a downward lifting force in the y-direction to the slider 210. The slider 210 flies from the surface of the hard disk due to the lifting force. In the vicinity of an edge part of an air outflow side (an edge part of bottom left of FIG. 14), the thin film magnetic head 1 is arranged.

A part in which the head gimbal assembly 220 is mounted on an arm 230 is referred to as a head arm assembly. The arm 230 allows the slider 210 to move in the track crossing direction x of the hard disk 262. One edge of the aim 230 is mounted on the base plate 224. On the other edge of the arm 230, a coil 231 is mounted, which forms one part of a voice coil motor. A bearing part 233 is disposed in the middle section of the arm 230. The arm 230 is rotatably supported by a shaft 234 mounted on the bearing part 233. The arm 230 and the voice coil motor for driving the arm 230 configure an actuator

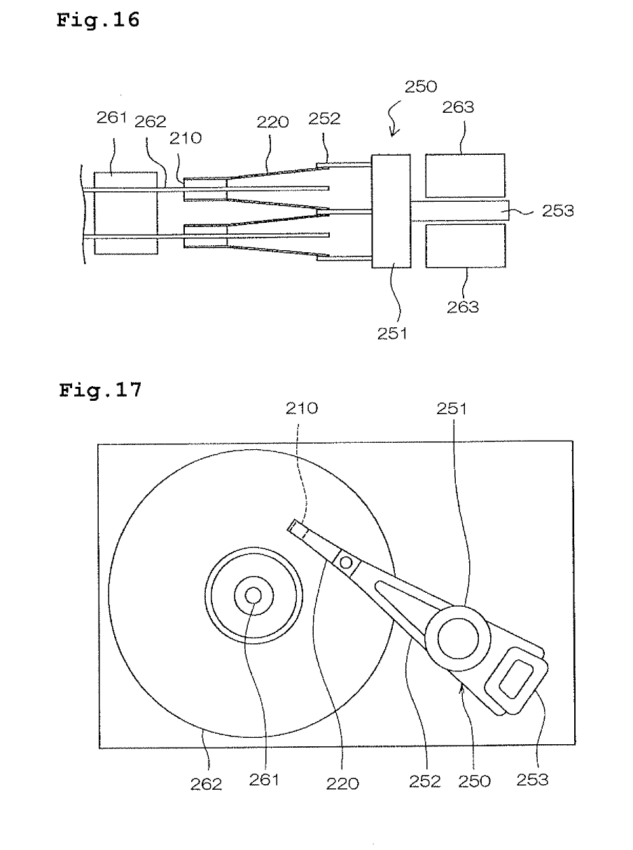

Next, referring to FIG. 16 and FIG. 17, a head stack assembly into which the above-mentioned slider 210 is integrated and a hard disk device will be explained. The head stack assembly includes a carriage 251 having a plurality of arms 252, wherein a head gimbal assembly 220 is mounted on each of the arm 251. FIG. 16 is a side view of the head stack assembly. FIG. 17 is a plan view of the hard disk device. The head stack assembly 250 includes the carriage 251 having a plurality of the arms 252. On each of the arms 252, the head gimbal assemblies 220 are mounted at an interval in the vertical direction. On a side of the carriage 251 opposite to the arm 252, the coil 253 is mounted, which forms a part of the voice coil motor. The voice coil motor has permanent magnets 263 disposed facing each other on both sides of the coil 253.

Referring to FIG. 17, the head stack assembly 250 is incorporated into the hard disk device. The hard disk device has multiple hard disks 262 mounted on a spindle motor 261. For each hard disk 262, two sliders 210 are disposed in a manner of facing each other and sandwiching the hard disk 262. An actuator and the assembly 250 excluding the slider 210, corresponding to a positioning device of the present invention, position the slider 210 with respect to the hard disk 262 in addition to supporting the slider 210. The slider 210 is moved in the track crossing direction of the hard disk 262 by the actuator, and is positioned with respect to the hard disk 262. The thin film magnetic head included in the slider 210 records information on the hard disk 262 by the recording head and reproduces the information recorded on the hard disk 262 by the reading element of the reproducing head.

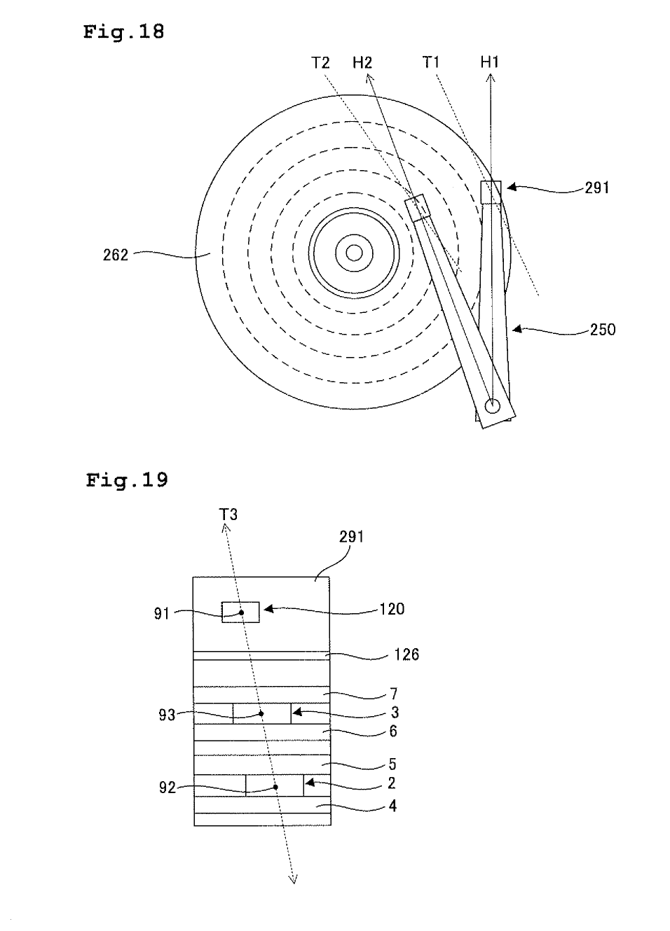

As illustrated in FIG. 18, directions 111 and H2 in which the head stack assembly 250 extends and directions T1 and T2 along which the track of the recording medium 262 moves are generally different. Considering such a conditions, it is preferred to determine a positional relation between the writing element 120 and the reading element 1 that configure the magnetic head.

FIG. 19 is a schematic view of a magnetic head seen from an ABS. As illustrated in FIG. 19, on the ABS S of the magnetic head 291, it is preferable to align a center part 91 of a magnetic field generation area of a writing element 120, a center part 92 of a first magnetic field sense area of a first MR part 2 and a center part 93 of a second magnetic field sense area of the second MR part 3 on a line T3. As a result, the writing element 120 and the first and second MR parts 2 and 3 can be arranged on the same track. Specifically, it is preferable that the line T3 coincides with a track direction under the situation where the magnetic head 291 is positioned in the center track among a plurality of tracks of the recording medium 262. This is because, when the magnetic head 291 moves on the recording medium 262, a range of an angle formed between the line T3 and the track direction becomes as small as possible.

A description of the preferred embodiment according to the present invention was given above in detail. However, it should be appreciated that a wide variety of alterations and modifications are possible as far as they do not depart from the spirit and scope of the attached claims.

What is claimed is:

1. A magnetic head comprising a reading element that reads magnetic information written on a recording medium, wherein
the reading element has a first magnetoresistive effect part (first MR part) and a second magnetoresistive effect part (second MR part), an electrical resistance of the first MR part changing according to an external magnetic field applied to a first magnetic field sense area, an electrical resistance of the second MR part changing according to an external magnetic field applied to a second magnetic field sense area,
a width of the second magnetic field sense area in a track width direction of the recording medium is larger than a width of the first magnetic field sense area in the track width direction,
a phase of change in the electrical resistance of the second MR part with respect to the external magnetic field substantially reverses to a phase in the electrical resistance of the first MR part, and
the magnetic head produces an output signal that comprises a sum of a first sense signal and a second sense signal, the first sense signal being based on the change of the electrical resistance of the first MR part, the second sense signal being normalized to a predetermined amount and being based on the change of the electrical resistance of the second MR part, and determines the magnetic information written on the recording medium from the output signal.

2. The magnetic head according to claim 1, wherein
the first MR part is a stack having
a first ferromagnetic layer whose magnetization direction is fixed,
a second ferromagnetic layer, as the first magnetic field sense area, whose magnetization direction changes according to the external magnetic field,
the second MR part is a stack having
a first ferromagnetic layer whose magnetization direction is fixed,
a second ferromagnetic layer, as the second magnetic field sense area, whose magnetization direction changes according to the external magnetic field,
an nonmagnetic intermediate layer between the first ferromagnetic layer and the second ferromagnetic layer, and
the magnetization direction of the first ferromagnetic direction of the first MR part is opposite to the magnetization direction of the first ferromagnetic direction of the second MR part.

3. The magnetic head according to claim 2, further comprising:
an antiferromagnetic layer that is disposed adjacent to the first ferromagnetic layer of the first MR part, and that is configured to fix the magnetization direction of the ferromagnetic layer, and
another antiferromagnetic layer that is disposed adjacent to the first ferromagnetic layer of the second MR part, and that is configured to fix the magnetization direction of the ferromagnetic layer.

4. The magnetic head according to claim 2, further comprising:
a single antiferromagnetic layer disposed between the first ferromagnetic layer of the first MR part and the first ferromagnetic layer of the second MR part and configured to fix the magnetization directions of the first ferromagnetic layers of the first and second MR parts.

5. The magnetic head according to claim 1, further comprising:
an analog circuit configured to produce the sum of the first sense signal and the second sense signal, the second sense signal being normalized to the predetermined amount.

6. The magnetic head according to claim 1, wherein
the magnetic head produces the sum of the first sense signal and the second sense signal, the second sense signal being normalized to be greater than 0 time and less than or equal to 0.5 times of an absolute value of a peak value of the first sense signal.

7. The magnetic head according to claim 1, wherein
a half width of a peak of the second sense signal is equal to or less than a track pitch of the recording medium.

8. The magnetic head according to claim 1, further comprising:
a writing element generating a magnetic field for writing the magnetic information on the recording medium, wherein
on an air bearing surface (ABS) opposing the recording medium, a center part of a magnetic field generation area of the writing element, a center part of a magnetic field sense area of the first MR part and a center part of a second magnetic field sense area of the second MR parₜ are configured to be linearly aligned.

9. A magnetic head comprising a reading element that reads magnetic information written on a recording medium, wherein
the reading element has a first magnetoresistive effect part (first MR part) and a second magnetoresistive effect part (second MR part), an electrical resistance of the first MR part changing according to an external magnetic field applied to a first magnetic field sense area, an electrical resistance of the second MR part changing according to an external magnetic field applied to a second magnetic field sense area,
a width of the second magnetic field sense area in a track width direction of the recording medium is larger than a width of the first magnetic field sense area in the track width direction;
a phase of change in the electrical resistance of the second MR part with respect to the external magnetic field is substantially the same as a phase in the electrical resistance of the first MR part, and
the magnetic head produces an output signal that comprises a difference between a first sense signal and a second sense signal, the first sense signal being based on the change of the electrical resistance of the first MR part, the second sense signal being normalized to a predetermined amount and being based on the change of the electrical resistance of the second MR part, and determines the magnetic information written on the recording medium from the output signal.

10. The magnetic head according to claim 9, wherein
the first MR part is a stack having
a first ferromagnetic layer whose magnetization direction is fixed,
a second ferromagnetic layer, as the first magnetic field sense area, whose magnetization direction changes according to the external magnetic field,
the second MR part is a stack having
a first ferromagnetic layer whose magnetization direction is fixed,
a second ferromagnetic layer, as the second magnetic field sense area, whose magnetization direction changes according to the external magnetic field,
an nonmagnetic intermediate layer between the first ferromagnetic layer and the second ferromagnetic layer, and
the magnetization direction of the first ferromagnetic direction of the first MR part is the same as the magnetization direction of the first ferromagnetic direction of the second MR part.

11. The magnetic head according to claim 9, further comprising:
an antiferromagnetic layer that is disposed adjacent to the first ferromagnetic layer of the first MR part, and that is configured to fix the magnetization direction of the ferromagnetic layer, and
another antiferromagnetic layer that is disposed adjacent to the first ferromagnetic layer of the second MR part, and that is configured to fix the magnetization direction of the ferromagnetic layer.

12. The magnetic head according to claim 9, further comprising:
an analog circuit configured to produce the difference between the first sense signal and the second sense signal, the second sense signal being normalized to the predetermined amount.

13. The magnetic head according to claim 9, wherein
the magnetic head produces the difference between the first sense signal and the second sense signal, the second sense signal being normalized to be greater than 0 time and less than or equal to 0.5 times of an absolute value of a peak value of the first sense signal.

14. The magnetic head according to claim 9, wherein
a half width of a peak of the second sense signal is equal to or less than a track pitch of the recording medium.

15. The magnetic head according to claim 9, further comprising:
a writing element generating a magnetic field for writing the magnetic information on the recording medium, wherein
on an air bearing surface (ABS) opposing the recording medium, a center part of a magnetic field generation area of the writing element, a center part of a magnetic field sense area of the first MR part and a center part of a second magnetic field sense area of the second MR part are configured to be linearly aligned.

16. A hard disk device, comprising:
a slider according to claim 1; and
a device for supporting the slider and for positioning the slider with respect to the recording medium.

17. The hard disk device according to claim 16, further comprising:
an analog/digital converter circuit that is configured to convert the first and second sense signals into digital signals; and
a control part that is configured to process the first and the second sense signals that are converted into the digital signals to produce the output signal.

18. A hard disk device, comprising:
a slider according to claim 9; and
a device for supporting the slider and for positioning the slider with respect to the recording medium.

19. The hard disk device according to claim 9, further comprising:
an analog/digital converter circuit that is configured to convert the first and second sense signals into digital signals; and
a control part that is configured to process the first and the second sense signals that are converted into the digital signals to produce the output signal.
